(19) United States
(12) Patent Application Publication
(10) Pub. No.: US 2026/0279044 A1
(43) Pub. Date: Sep. 17, 2026

(54) METHOD FOR PROCESSING IDENTIFICATION RESULT AND MAINTENANCE SYSTEM

(71) Applicant: Hangzhou Ruisheng Software Co., Ltd., Zhejiang (CN)

(72) Inventors: Qingsong Xu, Zhejiang (CN); Mingquan Chen, Zhejiang (CN)

(73) Assignee: Hangzhou Ruisheng Software Co., Ltd., Zhejiang (CN)

(21) Appl. No.: 19/564,080

(22) Filed: Mar. 11, 2026

(30) Foreign Application Priority Data
Mar. 17, 2025 (CN) 202510317271.8

(51) Int. Cl. G06V 20/10; G06F 16/535; G06F 16/583

(52) U.S. Cl. CPC G06V 20/188; G06F 16/535; G06F 16/583

(57) ABSTRACT

Disclosed are a method for processing an identification result and a related device. A method for processing an identification result includes: obtaining an image from a user, the image including a plant in a scene; identifying plant feature information and scene feature information of the image; extracting content information from a content database according to the plant feature information; inputting the content information and the scene feature information to a large language model to generate an identification result page from the content information based on the scene feature information; and displaying the generated identification result page on a user interface.

### CROSS-REFERENCE TO RELATED APPLICATION

This application claims the priority benefit of China application serial no. 202510317271.8, filed on Mar. 17, 2025. The entirety of the above-mentioned patent application is hereby incorporated by reference herein and made a part of this specification.

### BACKGROUND

### Technical Field

The present disclosure relates to the field of information processing technology, and more specifically, to a method for processing an identification result, an electronic device, a non-transitory storage medium, and a computer program product, and also to a maintenance system.

### Description of Related Art

At present, there are multiple applications (“APPs”) created for object identification, including, by way of example, applications for plant identification. Such Apps typically receive images input by users and, through identification models established on the basis of artificial intelligence technologies, identify the objects contained in such images to obtain identification results, which results are presented to users via a user interface.

### SUMMARY

A brief summary of the present disclosure is set forth below to provide a basic understanding of some aspects thereof. However, it should be understood that this summary is not an exhaustive overview of the present disclosure. It is not intended to identify key or critical features of the present disclosure, nor is it intended to limit the scope of the present disclosure. Its sole purpose is to present some concepts of the present disclosure in a simplified form as a prelude to the more detailed description that follows.

According to a first aspect of the present disclosure, a method for processing an identification result is provided, including: obtaining an image from a user, the image including a plant in a scene; identifying plant feature information and scene feature information of the image; extracting content information from a content database according to the plant feature information; inputting the content information and the scene feature information to a large language model (LLM) to generate an identification result page from the content information based on the scene feature information; and displaying the generated identification result page on a user interface.

In some embodiments, identifying the plant feature information and the scene feature information of the image includes: inputting the image to a first identification model to identify the plant feature information of the image, and inputting the image to a second identification model to identify the scene feature information of the image.

In some embodiments, the first identification model and the second identification model are the same identification model.

In some embodiments, the first identification model is a first multi-modal model, the first multi-modal model is trained using first training data, and the first training data includes plant images as samples and the plant feature information as labels of the samples. The second identification model is a second multi-modal model, the second multi-modal model is trained using second training data, and the second training data includes scene images as samples and the scene feature information as labels of the samples.

In some embodiments, the method includes: obtaining one or more of location information, time information, weather information, and climate information of the user; inputting the image and the one or more information into the first multi-modal model and the second multi-modal model respectively to obtain the plant feature information and the scene feature information of the image.

In some embodiments, the plant in the scene includes one or more of an indoor plant, a plant in an outdoor garden, a weed in an outdoor garden, a picked plant, a cut flower, a plant in a shopping scene, a plant in a public place, and a wild plant.

In some embodiments, the method includes: obtaining characteristic information of the user, the characteristic information indicating content preferences of the user in a corresponding scene; inputting the content information, the scene feature information, and the characteristic information to the large language model to generate the identification result page from the content information based on the scene feature information and the characteristic information.

In some embodiments, the characteristic information is obtained through historical data or interaction data of the user.

In some embodiments, the identification result page includes one or more content modules, the one or more content modules are divided according to topics, and each content module of the one or more content modules includes an operable user interface element.

In some embodiments, the method includes: after displaying the generated identification result page on the user interface, obtaining the characteristic information of the user based on an operation of the user on the operable user interface element in the identification result page; inputting the content information, the scene feature information and the characteristic information into the large language model to generate a new identification result page from the content information based on the scene feature information and the characteristic information; displaying the new identification result page on the user interface.

In some embodiments, the method includes, after displaying the generated identification result page on the user interface: obtaining first characteristic information indicating that the user is not satisfied with at least one of a topic and a content of a first content module based on the operation of the user on a first operable user interface element of the first content module in the identification result page, and inputting the content information, the scene feature information, and the first characteristic information to the large language model to regenerate a first identification result page for display on the user interface, such that compared with the previous identification result page, the first content module is not included in the first identification result page, or the at least one of the topic and the content of the first content module in the first identification result page is changed; or obtaining second characteristic information indicating that the user is satisfied with at least one of the topic and the content of the first content module based on the operation of the user on a second operable user interface element of the first content module in the identification result page, and inputting the second characteristic information to the large language model to reinforce a correlation between the scene feature information and the at least one of the topic and the content of the first content module in the large language model.

In some embodiments, the method includes: generating a maintenance solution according to the identification result page, the maintenance solution including one or more pairs, each pair of the one or more pairs including one or more maintenance tasks and an identifier of a maintenance device for executing the one or more maintenance tasks; displaying the maintenance solution on the user interface.

In some embodiments, the method includes: controlling a corresponding maintenance device according to the identifier of the maintenance device in the each pair of the one or more pairs in the maintenance solution to complete the one or more maintenance tasks in the pair.

According to a second aspect of the present disclosure, an electronic device is provided, including: a processor; and a memory storing computer-executable instructions, wherein the computer-executable instructions, when executed by the processor, enable the processor to execute the method for processing identification results according to any embodiment of the first aspect of the present disclosure.

According to a third aspect of the present disclosure, a non-transitory storage medium having computer-executable instructions stored thereon is provided, wherein the computer-executable instructions, when executed by a computer, enable the computer to execute the method for processing identification results according to any embodiment of the first aspect of the present disclosure.

According to a fourth aspect of the present disclosure, a computer program product is provided, the computer program product includes instructions, the instructions, when executed by a processor, implement the method for processing identification results according to any embodiment of the first aspect of the present disclosure.

According to a fifth aspect of the present disclosure, a maintenance system is provided, including: an electronic device, the electronic device including a processor and a memory coupled to the processor and storing instructions that, when executed by the processor, enable the processor to: obtain an image from a user, the image including a plant in a scene, identify plant feature information and scene feature information of the image, extract content information from a content database according to the plant feature information, input the content information and the scene feature information to a large language model to generate an identification result page from the content information based on the scene feature information, generate a maintenance solution according to the identification result page, the maintenance solution including one or more pairs, each pair of the one or more pairs including one or more maintenance tasks and an identifier of a maintenance device for executing the one or more maintenance tasks, transmit a command to a corresponding maintenance device according to the identifier of the maintenance device in the each pair of the one or more pairs in the maintenance solution to control the corresponding maintenance device to complete the one or more maintenance tasks in the pair; and a maintenance device communicatively coupled to the electronic device, the maintenance device being configured to execute the maintenance task in response to receiving the command from the electronic device.

In some embodiments, the maintenance system includes: a camera communicatively coupled to the electronic device, the camera being configured to capture the image including the plant in the scene and transmit the captured image to the electronic device, wherein the instructions include instructions that, when executed by the processor, enable the processor to execute the following operations: generating the identification result page based on the image received from the camera.

### BRIEF DESCRIPTION OF THE DRAWINGS

From the following description of embodiments of the present disclosure shown in conjunction with the accompanying drawings, the foregoing and other features and advantages of the present disclosure will become clear. The accompanying drawings are incorporated herein and form a part of the specification, further serving to explain the principles of the present disclosure and to enable those skilled in the art to make and use the present disclosure.

FIG. 1 shows a flowchart of a method for processing identification results according to some embodiments of the present disclosure.

FIG. 2 shows a schematic diagram of an exemplary user interface of a method for processing identification results according to some embodiments of the present disclosure.

FIG. 3 exemplarily shows a schematic diagram of an identification result page obtained by applying the method for processing identification results according to some embodiments of the present disclosure.

FIG. 4 exemplarily shows a non-limiting exemplary process of updating an identification result page by applying the method for processing identification results according to some embodiments of the present disclosure.

FIG. 5 shows a schematic block diagram of an electronic device according to some embodiments of the present disclosure.

FIG. 6 shows a schematic block diagram of a computer system on which embodiments of the present disclosure may be implemented.

FIG. 7 shows a schematic block diagram of a maintenance system according to some embodiments of the present disclosure.

Note that in the embodiments described below, the same reference numerals are sometimes used in common among different drawings to indicate the same parts or parts having the same function, and repeated description thereof is omitted. In some cases, similar numerals and letters are provided to indicate similar items, therefore, once an item is defined in one drawing, it does not need to be further discussed in subsequent drawings.

For ease of understanding, the position, size, and range of each structure shown in the drawings and the like may not represent the actual position, size, and range. Therefore, the present disclosure is not limited to the position, size, and range disclosed in the drawings and the like.

### DESCRIPTION OF THE EMBODIMENTS

Various exemplary embodiments of the present disclosure will be described in detail below with reference to the accompanying drawings. It should be noted that: unless otherwise specifically stated, the relative arrangement of components and steps, numerical expressions and numerical values set forth in these embodiments do not limit the scope of the present disclosure.

The following description of at least one exemplary embodiment is merely illustrative in nature and is in no way intended as any limitation to the present disclosure and its application or use. That is to say, the structures and methods herein are shown in an exemplary manner to explain different embodiments of the structures and methods in the present disclosure. However, those skilled in the art will understand that they merely explain exemplary ways of the present disclosure that may be provided to implement, rather than exhaustive ways. In addition, the drawings are not necessarily drawn to scale, and some features may be enlarged to show details of specific components.

Additionally, techniques, methods and devices known to those of ordinary skill in the relevant field may not be discussed in detail, but where appropriate, such techniques, methods and devices should be considered as part of the specification.

In all examples shown and discussed herein, any specific values should be interpreted as merely exemplary, and not as limitations. Therefore, other examples of exemplary embodiments may have different values.

When a user inputs into the application (“APP”) a photograph of a particular plant captured by the user, the APP may present within the user interface a page containing the identification results (hereinafter referred to as the “identification result pages”). Such identification result pages typically contain substantial textual and graphical information to assist the user in understanding the plant. However, if all content related to the plant is presented to the user in a flat and undifferentiated manner, it often imposes a significant reading and cognitive burden. Moreover, due to the excessive volume of information, the user may be unable to promptly identify the key points and may consequently overlook information of particular concern to the user. Although some APPs may filter the information presented on the identification result pages to display key information, the categories of such key information are often fixed. Users' priorities, however, vary depending on the context. For example, with respect to plants discovered while hiking outdoors, users are more concerned with the basic information and notable facts or curiosities of the plant, rather than issues relating to pests and diseases or care and maintenance methods. Conversely, when the user is at home or in a yard, the user is generally more concerned with pest and disease issues and care or maintenance methods for plants the user is cultivating. Accordingly, the presentation of a fixed set of key information categories fails to satisfy users' differing needs across varying contexts.

To this end, the present disclosure provides a method for processing identification results, which, on the basis of generating content information of the identification results from an image provided by a user, adjusts the content information of the identification results to be adapted to a scene through a large language model based on scene feature information identified from the image provided by the user, thereby enabling customization of the identification result page rendered to the user according to the current scene in which the plant in the image is located, prioritizing display of content that the user may care about most and be most interested in under the current scene from a large amount of information, so as to help the user quickly obtain key information of concern, improve information delivery efficiency, and improve user experience.

The method for processing identification results according to various embodiments of the present disclosure will be described in detail below with reference to the accompanying drawings. It may be understood that the actual method for processing the identification results may also include other steps, but in order to avoid obscuring the key points of the present disclosure, these other steps are not discussed herein and are not shown in the accompanying drawings.

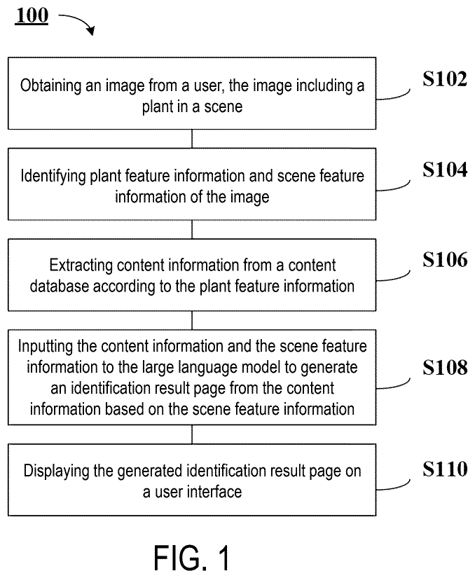

FIG. 1 shows a flowchart of a method 100 for processing an identification result according to some embodiments of the present disclosure. As shown in FIG. 1, the method 100 includes:

In step S102, obtaining an image from a user, the image including a plant in a scene;

In step S104, identifying plant feature information and scene feature information of the image;

In step S106, extracting content information from a content database according to the plant feature information;

In step S108, inputting the content information and the scene feature information to the large language model to generate an identification result page from the content information based on the scene feature information;

In step S110, displaying the generated identification result page on a user interface.

In some embodiments, an image from a user may simultaneously include a scene and a plant in the scene. In some embodiments, obtaining the image from the user may include obtaining multiple images from the user, where some images of the multiple images may only include or focus on rendering the scene in which the plant is located, while other images may only include or focus on rendering the plant. In some embodiments, obtaining the image from the user may include obtaining one or more images including a plant in a scene from a video from the user by means of video decoding and so on based on the video from the user.

In some examples, the plant in the scene may include one or more of an indoor plant, a plant in an outdoor garden, a weed in an outdoor garden, a picking plant, a cut flower, a plant in a shopping scene, a plant in a public place, and a wild plant. In this context, an outdoor garden generally refers to an outdoor planting area that is not in the wild, such as a garden, a vegetable plot, etc. It should be understood that the content listed above is only provided to exemplarily describe the plant in the scene, and is not provided to limit the scope of the present disclosure.

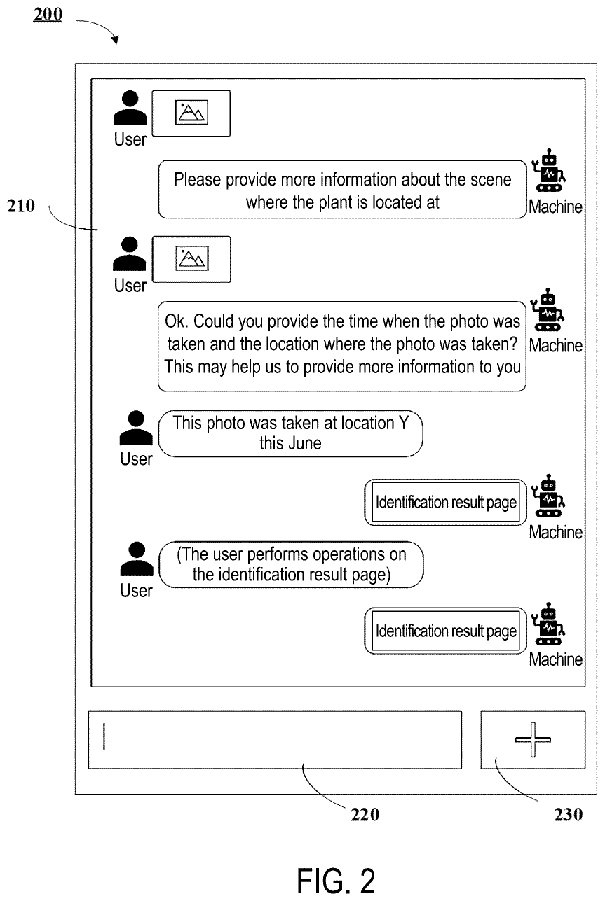

In some embodiments, the plant feature information of the identified image may indicate, for example, one or more of the species, growth stage, disease, etc. of the plant in the image. Accordingly, the content information extracted from the content database according to the identified plant feature information may include content about one or more of the species, growth stage, disease, etc. of the plant in the image. In addition, before identifying the plant feature information of the image, the image may also be preprocessed. The preprocessing may include segmentation, normalization, brightness adjustment, or noise reduction, etc. As a non-limiting example, a user interface 200 as shown in FIG. 2 may be provided, the user interface 200 includes a dialog box 210, an input box 220, and an input button 230, wherein the input box 220 is provided to receive text input by the user, and the input button 230 is provided to receive images, audio, video, etc. input by the user.

The content information may, for example, be pre-stored in a content database, such that in response to the image input by the user, corresponding content information may be extracted from the content database. For example, the content database may store names, types, growth stage information, maintenance information, diseases, and corresponding treatment and prevention methods of plants. Such content information related to plants may be stored in the content database in association with the plant feature information of the plant. The content information may be extracted based on a matching degree between the identified plant feature information and the plant feature information stored in the content database, for example, when the matching degree falls within a preset range. As a non-limiting example, a cosine similarity between a first vector representing the identified plant feature information and a second vector representing the plant feature information stored in the content database may be calculated. When the calculated cosine similarity exceeds a preset threshold, the identified plant feature information is considered to match the plant feature information stored in the content database, and the content information stored in the content database in association with the matched plant feature information is extracted. In addition, the content database may also be communicatively connected to an external source such as a cloud server. In some examples, when the content database is unable to provide corresponding content information, a request may be sent to the cloud server to obtain corresponding content information. The content information obtained from the cloud server may be stored in the content database.

In some examples, the content information may include content information in one or more of the following dimensions: basic information including the scientific name, common name, family and genus classification of the plant, or combinations thereof; appearance feature information describing the appearance features of the plant, such as the shape, size, color of the plant, the morphology of leaves, the morphology of flowers, the morphology of fruits, or combinations thereof; growth environment information describing the growth conditions suitable for the plant, such as light, moisture, soil type, temperature, or combinations thereof; distribution range information describing the place of origin or common distribution areas of the plant; maintenance information providing basic techniques for planting and maintaining this plant, such as watering frequency, fertilization requirements, pruning methods, or combinations thereof; plant usage information describing the uses of the plant, such as ornamental value, medicinal value, edible value, or other economic uses, or combinations thereof; reproduction information describing the reproduction methods of this plant, such as reproduction methods through seeds, cuttings, division, or other methods; disease prevention information describing common pest and disease problems of this plant and their prevention measures; feature information including the growth habits or characteristics of the plant, such as whether the plant is toxic, whether the plant is perennial, or combinations thereof; historical and cultural background information describing this plant, such as the special significance or symbolism of the plant in history/culture, or anecdotes related to the plant, or combinations thereof. It should be understood that the above listed content is only provided to exemplarily describe the content information, and is not provided to limit the scope of the present disclosure.

For example, the scene feature information may be identified according to the type of background in the image, the type of light source, the state of the plant, or a combination thereof.

In some embodiments, the scene feature information may be determined as an indoor plant according to the image satisfying one or more of the following conditions: the background is an indoor environment, for example, elements such as furniture, windows, walls appear; the plant is located in a flowerpot or container; at least one of artificial light sources or window light (for example, window reflection) is present. In some embodiments, the scene feature information may be determined as a plant in an outdoor garden according to the image satisfying one or more of the following conditions: an organized planting layout or flower beds are shown; the background includes elements such as yards, fences, garden decorations; the plant appears to be pruned and cared for. In some embodiments, the scene feature information may be determined as a weed in an outdoor garden according to the image satisfying one or more of the following conditions: the plant grows disorderly or the plant is mixed with various other plants or lawns; there is no obvious planting layout; neglected areas are shown. In some embodiments, the scene feature information may be determined as a picked plant according to the image satisfying one or more of the following conditions: the plant has traces of manual picking (for example, cut stems); the background is a field or a family car or a home environment; specific types of plants (for example, wildflowers or fruits). In some embodiments, the scene feature information may be determined as cut flowers according to the image satisfying one or more of the following conditions: the flowers are cut and placed in a vase or container; the background is an indoor environment; the flowers are used for decoration or other decorative elements are present. In some embodiments, the scene feature information may be determined as a plant in a shopping scene according to the image satisfying one or more of the following conditions: the plant is packaged in uniform containers or packaging; the background includes at least one of elements such as shelves, labels, price tags; elements such as goods or shopping carts are present. In some embodiments, the scene feature information may be determined as a plant in a public place according to the image satisfying one or more of the following conditions: the background includes at least one of elements such as public buildings, streets, urban landscapes; the plant is planted in public flower beds or large containers; there are signs of public activities (for example, parks). In some embodiments, the scene feature information may be determined as a wild plant according to the image satisfying one or more of the following conditions: the background includes natural landscapes (for example, forests, grasslands or mountains); the plant grows naturally and there is no obvious human intervention; the plant belongs to a local wild plant community.

Since the type of plant in the scene may affect the type of content information that the user focuses on, when filtering the content information, the plant feature information and the scene feature information may be combined to filter out the content information that the user is most concerned about at present from the complex content information.

In some embodiments, identifying the plant feature information and the scene feature information of the image may include: inputting the image to a first identification model to identify the plant feature information of the image, and inputting the image to a second identification model to identify the scene feature information of the image.

Specifically, in some embodiments, the first identification model may be a first multi-modal model, the first multi-modal model may be trained using first training data, and the first training data may include plant images as samples and the plant feature information as labels of the samples. Thus, the first multi-modal model trained via the first training data may identify the plant feature information from the image input by the user.

In some embodiments, the second identification model may be a second multi-modal model, the second multi-modal model may be trained using second training data, and the second training data may include scene images as samples and the scene feature information as labels of the samples. Accordingly, the second multi-modal model trained via the second training data may identify the scene feature information from the image input by the user.

In some embodiments, the first identification model and the second identification model may be the same identification model. In some examples, the same identification model may be, for example, a multi-modal model, the multi-modal model is trained with training data, the training data may include images containing plants in scenes as samples and the plant feature information and the scene feature information as labels of the samples. Thus, inputting an image to the same identification model may identify both the plant feature information of the image and the scene feature information of the image.

It may be understood that the training data may also include data of one or more modalities such as text, audio, video, etc., in addition to images. By performing joint training on data of these different modalities such as images, text, etc., the first identification model and/or the second identification model may learn the corresponding relationships between different modalities, thereby implementing cross-modal information expression and reasoning capabilities. In addition, through training data specific to the plant domain, identification capabilities in the plant domain are also injected into the first identification model and/or the second identification model.

In some embodiments, the method 100 may include: obtaining one or more of location information, time information, weather information, and climate information of the user, and inputting the image and the one or more information into the first multi-modal model and the second multi-modal model respectively to obtain the plant feature information and the scene feature information of the image. For example, in combination with the user interface 200 as shown in FIG. 2, the user may input his/her current location information through the input box 220 to determine whether the user is currently at home or in a tourist attraction, thereby helping to identify the scene feature information. Thus, obtaining other information besides the image may help to further filter out the key information that the user is concerned about from the complex content information. It may be understood that the obtained further information may be input by the user or may be prompted for user input by rendering relevant interactive questions on the user interface 200 as shown in FIG. 2.

The information obtained through interactive questions may be provided to help identify the scene feature information, identify the plant feature information, adjust the content information, adjust the identification result pages, etc. For the purpose of non-limiting explanation, for example, referring to FIG. 2, a user provides an image. The plant feature information of the image is identified according to the image provided by the user. However, since the image fails to provide sufficient information about the scene in which the plant is located, the scene feature information cannot be identified, the user is requested to provide more information about the scene in which the plant is located, for example a close-up photo of the scene. In addition, in order to further filter the content information, the user may also be requested to provide the time and location when the photo was taken. After the user answers that the photo was taken in June this year at location Y, the content information extracted from the content database is adjusted through the large language model based on the scene feature information and the time and location information, and then the identification result page generated by the large language model based on the adjusted content information is rendered to the user.

In some embodiments, the method 100 may include: obtaining the characteristic information of the user, the characteristic information indicating content preferences of the user in a corresponding scene; inputting the content information, the scene feature information, and the characteristic information into the large language model to generate the identification result page from the content information based on the scene feature information and the characteristic information. In some embodiments, the characteristic information is obtained through historical data or interaction data of the user.

In some examples, the historical data of the user may be stored in the user database. For example, when the user inputs the image to the APP, the user is usually in a logged-in state, that is, the account information of the user is known, and therefore the historical data of the user may be retrieved from the user database according to the account information of the user to obtain the characteristic information of the user. Illustratively, the characteristic information may include one or more of attribute characteristic information, operation characteristic information, and demand characteristic information of the user. The attribute characteristic information may include maintenance level information, etc. For example, if the user has previously maintained multiple plants and the growth states of the plants are all good, it indicates that a maintenance level of the user is relatively high. Conversely, if the user has never maintained plants or the growth states of the maintained plants are all poor, it indicates that the maintenance level of the user is relatively low. The operation characteristic information may include maintenance history information, etc. For example, when the user was previously maintaining a specific plant, the user only watered the plant after the plant became diseased, which caused the plant to wither, indicating that the operation of the user was incorrect and untimely. In another example, when the user was previously maintaining a specific plant, the user took preventive measures in time before the plant entered a disease-prone period, enabling the plant to grow healthily, indicating that the operation of the user was correct and timely. The demand characteristic information may include one or more of attention content information (for example, points of interest, key points), non-attention content information (for example, ignored points), detail preference information, layout preference information, and reading habit information of the user. Further, the characteristic information may include sub-items associated with scenes. For example, for the attribute characteristic information, the user may have different maintenance levels for plants in different scenes (such as plants planted indoors by the user and plants planted in an outdoor garden), and thus may require or prefer different levels of maintenance guidance. In still another example, for the demand characteristic information, the user may have different demands for plants in different scenes, for example, the points of attention, points of interest, key points, and ignored points are all different.

In some examples, the interaction data may be historical interaction data reflecting the user's historical interaction operations, or may be current interaction data reflecting the user's current interaction operations. In combination with the user interface 200 shown in FIG. 2, for example, for current interaction data, the user may input his/her own demand characteristic information through the input box 220. For example, the user may input instructions such as “I want to learn about the maintenance precautions for this plant” or “I don't want to learn about the detailed species information of this plant” in the form of text or voice, so that the large language model may adjust the rendered identification result page according to the characteristic information of the user. In yet another example, for historical interaction data, the user has previously indicated that he/she is not interested in the topics or content rendered by some content modules in the historically rendered identification result pages, therefore, these topics or content are automatically omitted when currently rendering the identification result page, so as to prevent the user from reading topics or content that he/she is not interested in, thereby improving user experience. Of course, the user's interaction operations may also include various interaction operations such as clicking, closing, deleting, doodling, and annotating.

After obtaining the content information about the image input by the user, the scene feature information, and the characteristic information about the user, the content information, the scene feature information, and the characteristic information may be input to the large language model to generate a personalized identification result page for the user. In some cases, the content information extracted from the content database may be input to the large language model as is. In other cases, the content information extracted from the content database may be preprocessed before being input to the large language model, so as to better satisfy user requirements. For example, the preprocessing may include using an Artificial Intelligence Generated Content (AIGC) model in combination with the characteristic information of the user to supplement the content information (for example, generating content of interest to the user according to the content information of interest to the user), reduce the content information (for example, removing content not of interest to the user according to the content information not of interest to the user), regenerate the content information (for example, adjusting the distribution of detail and brevity according to the detail and brevity preference information of the user), and the like.

Since the content that different users focus on is often different, and even the same user may focus on different content in different scenes, when filtering content information, the characteristic information of the user may be further combined to filter out the content that the user should focus on and the content that the user is interested in from a large amount of information, so as to enable customizing the presented identification result page for the user according to the personal features of the user, helping the user quickly grasp the key points, improving information transmission efficiency, and improving user experience.

In some embodiments, the identification result page includes one or more content modules, the one or more content modules are divided according to topics, and each content module of the one or more content modules includes an operable user interface element.

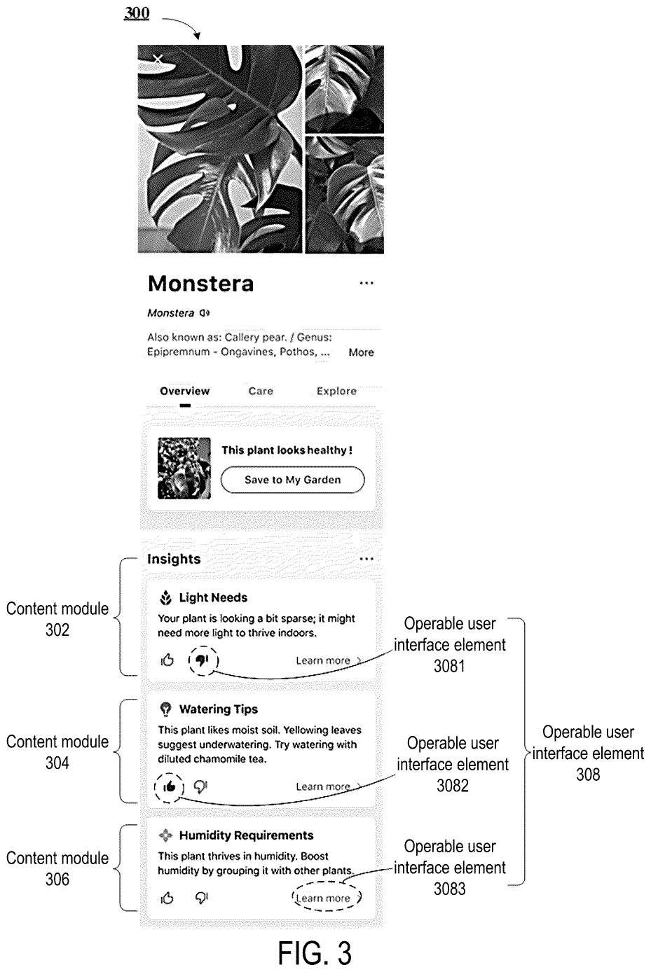

Referring to FIG. 3, FIG. 3 shows a schematic diagram of an identification result page 300 obtained by applying the method for processing the identification results according to some embodiments of the present disclosure. As shown in FIG. 3, the identification result page 300 includes content modules 302, 304, and 306. The content module 302 includes the topic “Light Needs” and the content reading “Your plant is looking a bit sparse; it might need more light to thrive indoors”, the content module 304 includes the topic “Watering Tips” and the content reading “This plant likes moist soil. Yellowing leaves suggest underwatering. Try watering with diluted chamomile tea”, the content module 306 includes the topic “Humidity Requirements” and the content reading “This plant thrives in humidity. Boost humidity by grouping it with other plants”.

Each of these three content modules includes three operable user interface elements 308, namely an operable user interface element 3081 for the user to express dissatisfaction with the topic and/or content rendered by the content module (for example, a “dislike” button), an operable user interface element 3082 for the user to express satisfaction with the topic and/or content rendered by the content module (for example, a “like” button), and an operable user interface element 3083 for the user to express interest in the topic rendered by the content module but the content rendered by the content module is insufficient to satisfy the user's expectation (or the user is satisfied with the topic of the content module but dissatisfied with the content of the content module) (for example, a “learn more” button). By setting these operable user interface elements at the content modules of the identification result page, user feedback on the rendered topics and content may be collected, thereby continuously optimizing the content recommendation logic.

It may be understood that, although the content modules listed herein are all used for rendering content information, the identification result page may also include a content module used for rendering the inference of the model on the scene where the plant is located, and the content module may also be configured to have an operable user interface element for collecting user feedback on the inferred scene information, so as to continuously optimize the scene inference logic.

In some embodiments, the method 100 may include: after displaying the generated identification result page on the user interface, obtaining the characteristic information of the user based on the operation of the user on the operable user interface element in the identification result page; inputting the content information, the scene feature information and the characteristic information into the large language model to generate a new identification result page from the content information based on the scene feature information and the characteristic information; displaying the new identification result page on the user interface.

Specifically, in some embodiments, the method 100 may include: after displaying the generated identification result page on the user interface: obtaining first characteristic information indicating that the user is not satisfied with at least one of a topic and a content of a first content module based on the operation of the user on the first operable user interface element of the first content module in the identification result page, and inputting the content information, the scene feature information, and the first characteristic information to the large language model to regenerate a first identification result page for displaying on the user interface, such that compared with the previous identification result page, the first content module is not included in the first identification result page, or at least one of the topic and the content of the first content module in the first identification result page is changed.

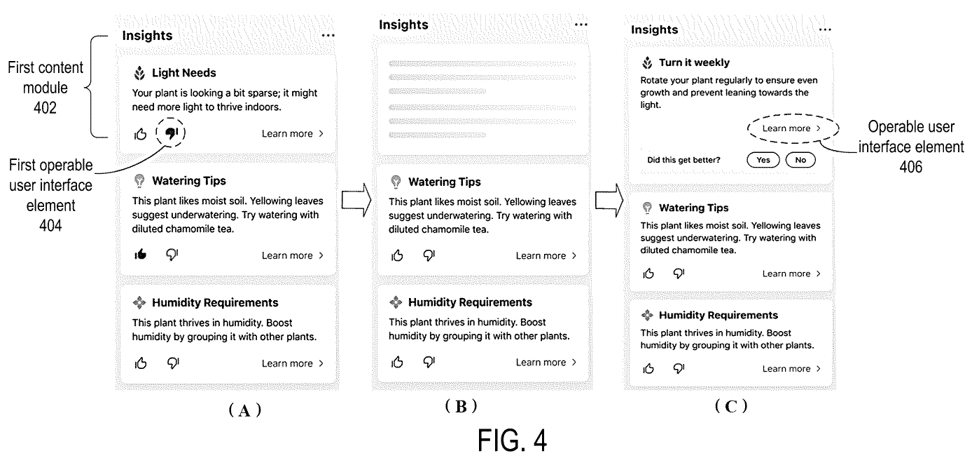

Referring to FIG. 4, a non-limiting exemplary process is shown for updating the identification result page by applying the method for processing the identification results according to some embodiments of the present disclosure. As shown in (A) of FIG. 4, after displaying the identification result page on the user interface, the first characteristic information indicating that the user is not satisfied with the topic and content of the first content module 402 is obtained based on the operation of the user on a first operable user interface element 404 (for example, a thumbs-down button) of the first content module 402 in the identification result page, and the content information, the scene information, and the first characteristic information are input to the large language model to regenerate the first identification result page as shown in (B) or (C) of FIG. 4. Compared with the identification result page shown in (A) of FIG. 4, the first content module 402 in the first identification result page shown in (B) of FIG. 4 is removed, and the topic of the first content module 402 in the first identification result page shown in (C) of FIG. 4 is changed from “Light Needs” to “Turn it weekly” and the content of the first content module 402 is changed from “Your plant is looking a bit sparse; it might need more light to thrive indoors” to “Rotate your plant regularly to ensure even growth and prevent leaning towards the light”. That is to say, (C) of FIG. 4 further attempts to recommend new content in the case where (B) of FIG. 4 removes the content that the user was originally not satisfied with. In addition, the updated first content module 402 may also be configured with an operable user interface elements 406, for example, a “yes” button and a “no” button as shown in (C) of FIG. 4, for collecting the user's satisfaction level with the updated topic and/or content. If the user operates the “no” button, the first characteristic information indicating that the user is not satisfied with the topic and/or content of the first content module 402 is obtained and the topic and/or content that the user was previously not satisfied with is removed or new topic and/or content continues to be regenerated to replace the topic and/or content that the user was previously not satisfied with until the user is satisfied or the maximum number of times is reached.

In some embodiments, the method 100 may include: after displaying the generated identification result page on the user interface: obtaining second characteristic information indicating that the user is satisfied with at least one of the topic and the content of the first content module based on the operation of the user on a second operable user interface element of the first content module in the identification result page, and inputting the second characteristic information to the large language model to reinforce an association degree between the scene feature information and the at least one of the topic and the content of the first content module in the large language model.

As a non-limiting embodiment, taking FIG. 3 as an example, after displaying the identification result page 300 on the user interface, the second characteristic information indicating that the user is satisfied with at least one of the topic and the content of the content module 302 is obtained based on the operation of the user on the operable user interface element 3082 of the content module 302 in the identification result page 300, and the second characteristic information is input to the large language model to reinforce the association degree between the scene feature information and the at least one of the topic and the content of the content module 302 in the large language model.

Thus, when the same scene feature information is received again in the future, the large language module may be more inclined to render topics and/or content with higher relevance to the scene feature information on the identification result page, thereby improving the screening accuracy of the large language model for content information and optimizing the generation efficiency of identification results.

After obtaining the identification result page, tasks associated therewith may be generated and displayed to the user according to the content in the identification result page, particularly the content information related to maintenance operations therein. In a case where a device capable of executing tasks is connected, the corresponding device may also be automatically controlled to execute the tasks.

Specifically, in some embodiments, the method 100 may include: generating a maintenance solution according to the identification result page, the maintenance solution including one or more pairs, each pair of the one or more pairs including one or more maintenance tasks and an identifier of a maintenance device for executing the one or more maintenance tasks; displaying the maintenance solution on the user interface.

The maintenance solution may include a daily maintenance solution, a treatment maintenance solution, etc., or a combination thereof. For example, when the identification result page does not involve a disease of the plant, a daily maintenance solution for the plant may be output; when the identification result page involves a disease of the plant, a treatment maintenance solution for the plant may be output, and optionally a coordinated daily maintenance solution may also be output.

For illustration purposes, a non-limiting exemplary application of the method 100 may include identification of a tomato plant maintained by the user in an outdoor garden. In this example, in the image input by the user, the tomato plant in the outdoor garden has already produced green fruits, therefore the identification result page finally generated based on this image may include a content module introducing growth stage information of the tomato plant, a content module introducing maintenance methods for the tomato plant at the current growth stage, and a content module introducing consumption methods for tomato fruits. In order to further help the user maintain the tomato, maintenance tasks may be generated according to the content in the identification result page, particularly the content in the content module introducing maintenance methods (for example, specific fertilization timing, watering frequency, light duration, etc.). After generating the maintenance tasks according to the identification result page, since the content database also stores identifiers of maintenance devices communicatively coupled to the user terminal, identifiers of maintenance devices associated with the maintenance tasks may also be determined from the content database according to the maintenance tasks, thereby generating the maintenance solution. After obtaining the maintenance solution, the maintenance solution may be displayed on the user interface. Thus, the user may know what kind of maintenance devices (for example, irrigation devices, fertilization devices, pruning devices, medication devices, light control devices, temperature control devices, humidity control devices, etc., or combinations thereof) should be used and what kind of maintenance tasks should be implemented to maintain the tomato. The maintenance tasks may include, for example, watering, spraying, fertilizing, pruning, weeding, pot rotation, sun exposure, shading, temperature adjustment, humidity adjustment, applying insecticides, and applying fungicides, etc. Specifically, the maintenance tasks may also include various parameters of the tasks, for example, watering time, interval, watering amount, fertilizer dosage, time, interval, pruning position, pesticide spraying dosage and position, etc.

In some embodiments, the method 100 may include: controlling a corresponding maintenance device to complete one or more maintenance tasks in the pair according to the identifier of the maintenance device in the each pair of one or more pairs in the maintenance solution.

Since the maintenance device usually has a communication function, a command may be transmitted to the maintenance device (for example, via Bluetooth protocol, Zigbee protocol, etc.). For example, in the foregoing example, the maintenance solution may include two pairs of {watering task, identifier of the irrigation device} and {fertilizing task, identifier of the fertilizing device}. According to the identifier, commands indicating to execute the irrigation task and the fertilizing task are sent to the corresponding irrigation device and fertilizing device respectively, thereby controlling the irrigation device and the fertilizing device to automatically complete the irrigation task and the fertilizing task, thereby reducing the maintenance burden of the user and improving the maintenance efficiency.

In addition to automatically executing the maintenance solution, in some embodiments, after displaying the maintenance solution, the user may be further asked whether to confirm execution of the maintenance solution, and after the user confirms execution of the maintenance solution, the corresponding maintenance device is controlled according to the maintenance solution to complete the corresponding maintenance task. For example, after the user confirms execution of the maintenance solution, the characteristic information of the user may be updated based on the maintenance solution, such as maintenance level information, maintenance history information, etc. Alternatively, after the maintenance solution is executed, the characteristic information of the user may be updated based on the execution data returned by the maintenance device, such as the maintenance level information, the maintenance history information, etc. In this way, when the image of the user is obtained again, the identification result page and the corresponding maintenance solution may be generated in combination with the updated characteristic information of the user.

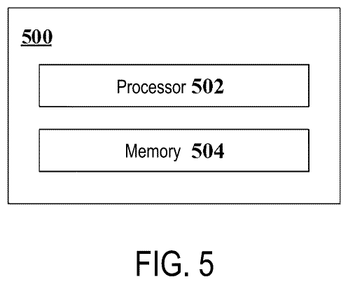

The present disclosure also provides an electronic device in another aspect. Referring to FIG. 5, FIG. 5 shows a schematic block diagram of an electronic device 500 according to some embodiments of the present disclosure. As shown in FIG. 5, the electronic device 500 includes a processor 502 and a memory 504 storing computer-executable instructions, and the computer-executable instructions, when executed by the processor 502, enable the processor 502 to execute the method for processing the identification results according to any of the foregoing embodiments of the present disclosure. The processor 502 may be, for example, a central processing unit (CPU) of the electronic device 500. The processor 502 may be any type of general-purpose processor, or may be a processor specifically designed for processing identification results, such as an application-specific integrated circuit (“ASIC”). The memory 504 may be coupled to the processor 502 and may include various computer-readable media accessible by the processor 502. In various embodiments, the memory 504 described herein may include volatile and non-volatile media, removable and non-removable media. For example, the memory 504 may include any combination of the following: random access memory (“RAM”), dynamic RAM (“DRAM”), static RAM (“SRAM”), read-only memory (“ROM”), flash memory, cache memory, and/or any other type of non-transitory computer-readable medium. The memory 504 may store instructions that, when executed by the processor 502, enable the processor 502 to execute the method for processing the identification results according to any of the foregoing embodiments of the present disclosure. In some embodiments, the electronic device 500 may be implemented as a smartphone, a smart camera, a computer, or the like.

The electronic device 500 is configured to execute the method 100 described in any of the foregoing embodiments, therefore reference may be made to the descriptions of the various embodiments of the method 100 above, which will not be repeated here.

The present disclosure also provides a non-transitory storage medium having computer-executable instructions stored thereon, wherein the computer-executable instructions, when executed by a computer, enable the computer to execute the method for processing the identification results according to any of the foregoing embodiments of the present disclosure.

The present disclosure also provides a computer program product, the computer program product may include instructions, when the instructions are executed by a processor, may implement the method for processing the identification results according to any of the foregoing embodiments of the present disclosure. The instructions may be any instruction set to be executed directly by one or more processors, such as machine codes, or any instruction set to be executed indirectly, such as scripts. The instructions may be stored in an object code format for direct processing by one or more processors, or stored in any other computer language, including scripts or collections of independent source code modules that are interpreted on demand or compiled ahead of time.

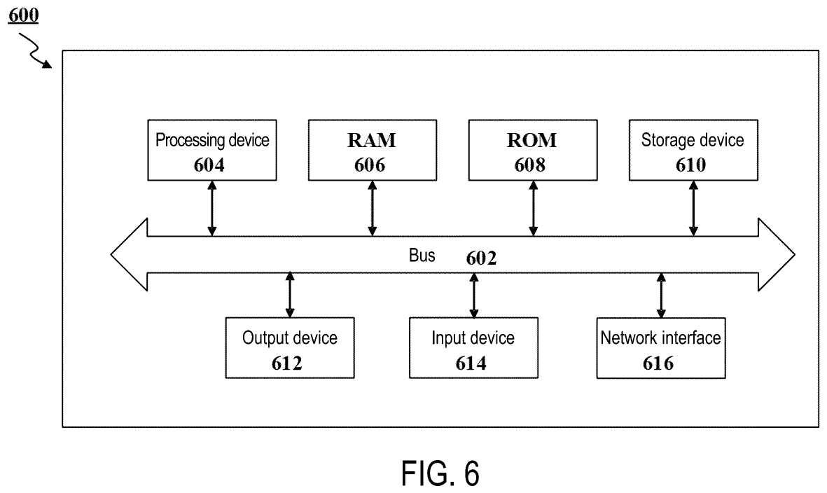

FIG. 6 shows a schematic block diagram of a computer system 600 on which embodiments of the present disclosure may be implemented. The computer system 600 include a bus 602 or other communication mechanism for transmitting information, and a processing device 604 coupled to the bus 602 for processing information. The computer system 600 also include a memory 606 coupled to the bus 602 for storing instructions to be executed by the processing device 604, and the memory 606 may be a random access memory (RAM) or other dynamic storage device. The memory 606 may also be used for storing temporary variables or other intermediate information during execution of instructions to be executed by the processing device 604. The computer system 600 also include a read-only memory (ROM) 608 or other static storage device coupled to the bus 602 for storing static information and instructions for the processing device 604. A storage device 610 such as a magnetic disk or an optical disk is provided and coupled to the bus 602 for storing information and instructions. The computer system 600 may be coupled via the bus 602 to an output device 612 for providing output to a user, such as but not limited to a display (such as a cathode ray tube (CRT) or liquid crystal display (LCD)), a speaker, etc. An input device 614 such as a keyboard, a mouse, a microphone, etc. is coupled to the bus 602 for transmitting information and command selections to the processing device 604. The computer system 600 may execute embodiments of the present disclosure. Consistent with some embodiments of the present disclosure, result is provided by the computer system 600 in response to the processing device 604 executing one or more sequences of one or more instructions contained in the memory 606. Such instructions may be read into the memory 606 from another computer-readable medium such as the storage device 610. Execution of the sequences of instructions contained in the memory 606 enable the processing device 604 to execute the method described herein. Alternatively, hardwired circuitry may be used in place of or in combination with software instructions to implement the present teachings. Therefore, embodiments of the present disclosure are not limited to any specific combination of hardware circuitry and software. In various embodiments, the computer system 600 may be connected across a network via a network interface 616 to one or more other computer systems such as the computer system 600 to form a networked system. The network may include a private network or a public network such as the Internet. In the networked system, one or more computer systems may store data and supply the data to other computer systems. As used herein, the term “computer-readable medium” refers to any medium that participates in providing instructions to the processing device 604 for execution. Such medium may take many forms, including but not limited to non-volatile medium, volatile medium, and transmission medium. Non-volatile medium include, for example, optical disks or magnetic disks such as the storage device 610. Volatile medium include dynamic memory such as the memory 606. Transmission medium include coaxial cables, copper wire, and optical fibers, including wiring including the bus 602. Common forms of the computer-readable medium or computer program products include, for example, floppy disks, flexible disks, hard disks, magnetic tape, or any other magnetic medium, CD-ROM, digital video disc (DVD), Blu-ray disc, any other optical medium, thumb drives, memory cards, RAM, PROM and EPROM, flash EPROM, any other memory chip or cartridge, or any other tangible medium from which a computer may read. Various forms of the computer-readable medium may be involved in carrying one or more sequences of one or more instructions to the processing device 604 for execution. For example, the instructions may initially be carried on a magnetic disk of a remote computer. The remote computer may load the instructions into its dynamic memory and send the instructions over a telephone line using a modem. A modem local to the computer system 600 may receive the data on the telephone line and use an infrared transmitter to convert the data into an infrared signal. An infrared detector coupled to the bus 602 may receive the data carried in the infrared signal and place the data on the bus 602. The bus 602 carries the data to the memory 606, and the processing device 604 retrieves the instructions from the memory 606 and executes the instructions. For example, the instructions received by the memory 606 may be stored on the storage device 610 before or after being executed by the processing device 604.

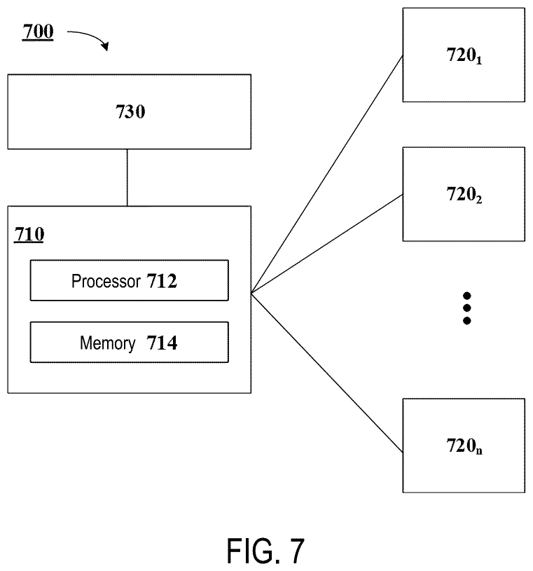

FIG. 7 shows a schematic block diagram of a maintenance system 700 according to some embodiments of the present disclosure. The maintenance system 700 includes an electronic device 710, which includes a processor 712 and a memory 714 coupled to the processor 712 and storing instructions. The electronic device 710 may, for example, adopt but is not limited to the form of the electronic device 500 or the computer system 600, and may be implemented as, for example but not limited to, a smartphone, a smart camera, a computer, etc. The memory 714 may store instructions that, when executed by the processor 712, enable the processor 712 to execute the method for processing the identification results according to any of the aforementioned embodiments of the present disclosure. The maintenance system 700 further includes (one or more) maintenance devices (for example, 7201, 7202, . . . , 720n) communicatively coupled to the electronic device 710, which are configured to execute maintenance tasks in response to receiving commands from the electronic device 710.

Specifically, in some embodiments, the instructions stored in the memory 714, when executed by the processor 712, may enable the processor 712 to: obtain the image from the user, the image including the plant in the scene; identify the plant feature information and the scene feature information of the image; extract the content information from the content database according to the plant feature information; input the content information and the scene feature information into the large language model to generate the identification result page from the content information based on the scene feature information; generate the maintenance solution according to the identification result page, the maintenance solution including one or more pairs, each pair of the one or more pairs including one or more maintenance tasks and the identifier of the maintenance device for executing the one or more maintenance tasks; transmit the command to the corresponding maintenance device (e.g., 7201, 7202, . . . , 720n) according to the identifier of the maintenance device in the each pair of the one or more pairs in the maintenance solution to control the corresponding maintenance device (e.g., 7201, 7202, . . . , 720n) to complete the one or more maintenance tasks in the pair.

In some embodiments, the electronic device 710 includes the user interface (not shown). For example, the identification result page may be displayed on the user interface, and/or the maintain solution may be displayed on the user interface.

In some embodiments, the maintenance device (e.g., 7201, 7202, . . . , 720n) is configured to transmit execution data to the electronic device 710 in response to execution of the maintenance task. Thus, the instruction stored in the memory 714 may include instruction that, when executed by the processor 712, enable the processor 712 to execute the following operations: updating the characteristic information of the user based on the execution data received from the maintenance device. In this way, when the image of the user is obtained again, the identification result page and the corresponding maintenance solution may be generated in combination with the updated characteristic information of the user.

In some embodiments, the maintenance system 700 may include a camera 730 communicatively coupled to the electronic device 710. The camera 730 may be configured to capture the image including the plant in the scene and transmit the captured image to the electronic device 710. Thus, the instructions stored in the memory 714 may include instructions that, when executed by the processor 712, enable the processor 712 to execute the following operations: generate the identification result page based on the image received from the camera 730.

For example, images received from the camera 730 may be input to the first identification model and second identification model for processing. For instance, close-up images or videos of one or more characteristic parts of a plant in a scene and/or panoramic and/or partial images or videos of the scene may be required, in which case these images or videos may not need to be input by the user, but may be automatically obtained by the camera 730. Alternatively, when images from the user cannot be identified due to various reasons such as insufficient clarity, the user may not need to re-input images, but the camera 730 may automatically obtain images. That is, the images captured by the camera 730 may be provided to assist in generating the identification results.

The camera 730 may be any suitable imaging device for monitoring plants. The plant in the scene may be positioned in the field of view of the camera 730 so that the camera may capture images including the plant in the scene. In some examples, the camera 730 may be installed in a user's outdoor garden or home scene.

In some embodiments, the instructions stored in the memory 714, when executed by the processor 712, may enable the processor 712 to: obtain the image from the camera 730; identify the plant feature information and the scene feature information of the image; extract the content information from the content database according to the plant feature information; input the content information and the scene feature information to the large language model to generate the identification result page from the content information based on the scene feature information; generate the maintenance solution according to the identification result page, the maintenance solution including one or more pairs, each pair of the one or more pairs including one or more maintenance tasks and the identifier of the maintenance device for executing the one or more maintenance tasks; transmit the command to the corresponding maintenance device (example, 7201, 7202, . . . , 720n) according to the identifier of the maintenance device in the each pair of the one or more pairs in the maintenance solution to control the corresponding maintenance device (example, 7201, 7202, . . . , 720n) to complete the one or more maintenance tasks in the pair. That is to say, the image captured by the camera 730 may be provided to autonomously generate the identification result and automatically execute the maintenance solution, so as to implement fully automatic monitoring and maintenance of the plant.

Various embodiments of the maintenance system 700 may be similar to any embodiment referring to the foregoing aspects of the present disclosure, and will not be described in detail herein.

One or more exemplary embodiments of the present disclosure have been described above. Other embodiments are within the scope of the appended claims. In some cases, the actions or steps recited in the claims may be executed in an order different from that in the embodiments and may still achieve desired results. Additionally, the processes depicted in the accompanying drawings do not necessarily require the particular order shown or a sequential order to achieve desired results. In some embodiments, multitasking and parallel processing are also possible or may be advantageous.

The systems, devices, modules or units illustrated in the above embodiments may be specifically implemented by computer chips or entities, or by products having some functions. A typical embodiment device is a server system. Of course, the present disclosure does not exclude that with the development of computer technology in the future, the computer implementing the functions of the above embodiments may be, for example, a personal computer, a laptop computer, a vehicle-mounted human-machine interaction device, a cellular phone, a camera phone, a smart phone, a personal digital assistant, a media player, a game console, a tablet computer, a wearable device, or any combination thereof.

The terms “include”, “comprise” or any other variations thereof are intended to cover non-exclusive inclusion, such that a process, method, product or device that includes a series of elements includes not only those elements, but also other elements not explicitly listed, or also includes elements inherent to such process, method, product or device. Without further limitation, it is not excluded that there are additional identical or equivalent elements in the process, method, product or device that includes the stated elements. For example, if words such as “first”, “second” are provided to indicate names, they do not indicate any particular order.

For convenience of description, when describing the above device, it is described separately by dividing into various modules according to functions. Of course, when implementing one or more embodiments of the present disclosure, the functions of each module may be implemented in one or more pieces of software and/or hardware, or the modules implementing the same function may be implemented by a combination of multiple sub-modules or sub-units, etc. The device embodiments described above are merely illustrative, for example, the division of the units is merely a logical function division, and there may be other division methods in actual embodiment, for example, multiple units or components may be combined or may be integrated into another system, or some features may be ignored or not executed. On another point, the mutual coupling or direct coupling or communication connection shown or discussed may be through some interfaces, and the indirect coupling or communication connection of devices or units may be electrical, mechanical, or other forms.

The present disclosure is described with reference to flowcharts and/or block diagrams of methods, devices (systems), and computer program products according to embodiments of the present disclosure. It should be understood that each process and/or block in the flowcharts and/or block diagrams, and combinations of processes and/or blocks in the flowcharts and/or block diagrams, may be implemented by computer program instructions. These computer program instructions may be provided to a processor of a general-purpose computer, a special-purpose computer, an embedded processor, or other programmable data processing device to produce a machine, such that the instructions executed by the processor of the computer or other programmable data processing device produce a device for implementing the functions specified in one or more processes of the flowcharts and/or one or more blocks of the block diagrams.

These computer program instructions may also be stored in a computer-readable memory that may direct a computer or other programmable data processing device to work in a specific manner, such that the instructions stored in the computer-readable memory produce an article of manufacture including an instruction device that implements the functions specified in one or more processes of the flowchart and/or one or more blocks of the block diagram. These computer program instructions may also be loaded onto a computer or other programmable data processing device, such that a series of operational steps are executed on the computer or other programmable device to produce a computer-implemented process, whereby the instructions executed on the computer or other programmable device provide steps for implementing the functions specified in one or more processes of the flowchart and/or one or more blocks of the block diagram.

Those skilled in the art should understand that one or more embodiments of the present disclosure may take the form of an entirely hardware embodiment, an entirely software embodiment, or an embodiment combining software and hardware aspects. Moreover, one or more embodiments of the present disclosure may take the form of a computer program product implemented on one or more computer-usable storage media (including but not limited to magnetic disk storage, CD-ROM, optical storage, etc.) having computer-usable program code embodied therein.

One or more embodiments of the present disclosure may be described in the general context of computer-executable instructions executed by a computer, such as program modules. Generally, program modules include routines, programs, objects, components, data structures, etc. that execute specific tasks or implement specific abstract data types. One or more embodiments of the present disclosure may also be practiced in distributed computing environments in which tasks are executed by remote processing devices that are connected through a communication network. In a distributed computing environment, program modules may be located in local and remote computer storage media including storage devices.

The same or similar parts among various embodiments of the present disclosure may serve as cross-reference for each other, and each embodiment focuses on the differences from other embodiments. In particular, for the device embodiments, since they are basically similar to the method embodiments, the description is relatively simple, and for related parts, reference may be made to the partial description of the method embodiments. In the description of the present disclosure, descriptions referring to terms such as “one embodiment”, “some embodiments”, “example”, “specific example”, or “some examples”, “exemplary”, etc. mean that specific features, structures, materials or characteristics described in connection with the embodiment or example are included in at least one embodiment or example of the present disclosure. In the present disclosure, the schematic representations of the above terms do not necessarily refer to the same embodiment or example. Moreover, the specific features, structures, materials or characteristics described may be combined in any one or more embodiments or examples in a suitable manner. In addition, those skilled in the art may combine and integrate different embodiments or examples described in the present disclosure and features of different embodiments or examples without contradicting each other.

Additionally, when used in the present disclosure, the words “herein”, “above”, “below”, “hereinafter”, “hereinbefore” and words of similar meaning shall refer to the present disclosure as a whole and not to any particular part of the present disclosure. Furthermore, unless otherwise expressly stated or otherwise understood in the context in which they are used, conditional language used herein, such as “may”, “might”, “for example”, “such as”, etc., is generally intended to express that some embodiments include, while other embodiments do not include, some features, elements and/or states. Thus, such conditional language is generally not intended to imply that features, elements and/or states are in any way required for one or more embodiments, or whether these features, elements and/or states are included or are executed in any particular embodiment.

The foregoing is merely an embodiment of one or more embodiments of the present disclosure, and is not provided to limit one or more embodiments of the present disclosure. For those skilled in the art, one or more embodiments of the present disclosure may have various modifications and variations. Any modifications, equivalent substitutions, improvements, etc. made within the spirit and principle of the present disclosure shall be included within the scope of the claims.

What is claimed is:

1. A method for processing an identification result, comprising:
obtaining an image from a user, the image comprising a plant in a scene;
identifying plant feature information and scene feature information of the image;
extracting content information from a content database according to the plant feature information;
inputting the content information and the scene feature information to a large language model to generate an identification result page from the content information based on the scene feature information; and
displaying the generated identification result page on a user interface.

2. The method according to claim 1, wherein identifying the plant feature information and the scene feature information of the image comprises:
inputting the image to a first identification model to identify the plant feature information of the image, and inputting the image to a second identification model to identify the scene feature information of the image.

3. The method according to claim 2, wherein,
the first identification model is a first multi-modal model, the first multi-modal model is trained using first training data, and the first training data comprises plant images as samples and the plant feature information as labels of the samples;
the second identification model is a second multi-modal model, the second multi-modal model is trained using second training data, and the second training data comprises scene images as samples and the scene feature information as labels of the samples.

4. The method according to claim 3, comprising:
obtaining one or more information of location information, time information, weather information, and climate information of the user;
inputting the image and the one or more information into the first multi-modal model and the second multi-modal model respectively to obtain the plant feature information and the scene feature information of the image.

5. The method according to claim 1, wherein the plant in the scene comprises one or more of an indoor plant, a plant in an outdoor garden, a weed in an outdoor garden, a picked plant, a cut flower, a plant in a shopping scene, a plant in a public place, and a wild plant.

6. The method according to claim 1, comprising:
obtaining characteristic information of the user, the characteristic information indicating content preferences of the user in a corresponding scene, wherein the characteristic information is obtained through historical data or interaction data of the user;
inputting the content information, the scene feature information, and the characteristic information to the large language model to generate the identification result page from the content information based on the scene feature information and the characteristic information.

7. The method according to claim 1, wherein the identification result page comprises one or more content modules, the one or more content modules are divided according to topics, and each content module of the one or more content modules comprises an operable user interface element,
the method comprises:
after displaying the generated identification result page on the user interface, obtaining characteristic information of the user based on an operation of the user on the operable user interface element in the identification result page;
inputting the content information, the scene feature information and the characteristic information into the large language model to generate a new identification result page from the content information based on the scene feature information and the characteristic information; and
displaying the new identification result page on the user interface.

8. The method according to claim 7, the method comprising, after displaying the generated identification result page on the user interface:
obtaining first characteristic information indicating that the user is not satisfied with at least one of a topic and a content of a first content module based on an operation of the user on a first operable user interface element of the first content module in the identification result page, and inputting the content information, the scene feature information, and the first characteristic information to the large language model to regenerate a first identification result page for display on the user interface, such that compared with the previous identification result page, the first content module is not comprised in the first identification result page, or the at least one of the topic and the content of the first content module in the first identification result page is changed; or
obtaining second characteristic information indicating that the user is satisfied with at least one of the topic and the content of the first content module based on the operation of the user on a second operable user interface element of the first content module in the identification result page, and inputting the second characteristic information to the large language model to reinforce a correlation between the scene feature information and the at least one of the topic and the content of the first content module in the large language model.

9. The method according to claim 1, comprising:
generating a maintenance solution according to the identification result page, the maintenance solution comprising one or more pairs, each pair of the one or more pairs comprising one or more maintenance tasks and an identifier of a maintenance device for executing the one or more maintenance tasks;
displaying the maintenance solution on the user interface,
wherein the method further comprises:
controlling a corresponding maintenance device according to the identifier of the maintenance device in the each pair of the one or more pairs in the maintenance solution to complete the one or more maintenance tasks in the pair.

10. A maintenance system, comprising:
an electronic device, the electronic device comprising a processor and a memory coupled to the processor and storing instructions that, when executed by the processor, enable the processor to:
obtain an image from a user, the image comprising a plant in a scene,
identify plant feature information and scene feature information of the image,
extract content information from a content database according to the plant feature information,
input the content information and the scene feature information to a large language model to generate an identification result page from the content information based on the scene feature information,
generate a maintenance solution according to the identification result page, the maintenance solution comprising one or more pairs, each pair of the one or more pairs comprising one or more maintenance tasks and an identifier of a maintenance device for executing the one or more maintenance tasks,
transmit a command to a corresponding maintenance device according to the identifier of the maintenance device in the each pair of the one or more pairs in the maintenance solution to control the corresponding maintenance device to complete the one or more maintenance tasks in the pair; and
a maintenance device communicatively coupled to the electronic device, the maintenance device being configured to execute the maintenance task in response to receiving the command from the electronic device.

11. The maintenance system according to claim 10, comprising:
a camera communicatively coupled to the electronic device, the camera being configured to capture the image comprising the plant in the scene and transmit the captured image to the electronic device,
wherein the instructions comprise instructions that, when executed by the processor, enable the processor to execute following operation:
generating the identification result page based on the image received from the camera.
